(19) United States
(12) Patent Application Publication
(10) Pub. No.: US 2011/0072368 A1
(43) Pub. Date: Mar. 24, 2011

(54) Personal navigation device and related method for dynamically downloading markup language content and overlaying existing map data

(76) Inventors: Rodney Macfarlane, Auckland (NZ); Paul Ranford, Auckland (NZ)

(21) Appl. No.: 12/563,154

(22) Filed: Sep. 20, 2009

(51) Int. Cl. G06F 3/01; G06F 3/048

(52) U.S. Cl. 715/760; 715/768; 715/848

(57) ABSTRACT

A method of overlaying markup language content on map data in a personal navigation device includes outputting map data on a display of the personal navigation device with a map display program, receiving markup language content with a markup language renderer, and overlaying the markup language content received by the markup language renderer on the map data output by the map display program.

### BACKGROUND OF THE INVENTION

1. Field of the Invention

The invention relates to a method of displaying map data on a personal navigation device, and more particularly, to a method for enhancing map data in a personal navigation device with overlayed markup language content.

2. Description of the Prior Art

Global Positioning System (GPS) based navigation devices are well known and are widely employed as in-car navigation devices. Common functions of a navigation device include providing a map database for generating navigation instructions that are then shown on a display of the navigation device. These navigation devices are often mounted on or in the dashboard of a vehicle using a suction mount or other mounting means.

The term “navigation device” refers to a device that enables a user to navigate to a pre-defined destination. The device may have an internal system for receiving location data, such as a GPS receiver, or may merely be connectable to a receiver that can receive location data. The device may compute a route itself, or communicate with a remote server that computes the route and provides navigation information to the device, or a hybrid device in which the device itself and a remote server both play a role in the route computation process. Personal GPS navigation devices are not permanently integrated into a vehicle but instead are devices that can readily be mounted in or otherwise used inside a vehicle. Generally (but not necessarily), they are fully self-contained—i.e. include an internal GPS antenna, navigation software and maps and can hence plot and display a route to be taken.

One major problem that occurs with personal navigation devices is dealing with updates for map data that is displayed on the personal navigation device. When map data is out of date, users of ten must go through lengthy steps to download updated map data.

Additionally, manufacturers personal navigation devices have no way to update the graphical user interface (GUI) of the personal navigation devices without formally releasing a new version of the software running on the personal navigation devices. Thus, the difficulty in providing quick and dynamic updates to content displayed on personal navigation devices is a major issue that is in need of a solution.

### SUMMARY OF THE INVENTION

It is therefore one of the primary objectives of the claimed invention to provide a personal navigation device and a related method for dynamically downloading markup language content that is used for overlaying existing map data.

According to an exemplary embodiment of the claimed invention, a method of overlaying markup language content on map data in a personal navigation device is disclosed. The method includes outputting map data on a display of the personal navigation device with a map display program, receiving markup language content with a markup language renderer, and overlaying the markup language content received by the markup language renderer on the map data output by the map display program.

According to another exemplary embodiment of the claimed invention, a personal navigation device overlaying markup language content on displayed map data is disclosed. The personal navigation device includes a display for displaying map data and overlayed markup language content, an input device for receiving input from a user of the personal navigation device, and a memory for storing map data and markup language content, The personal navigation device also includes a map display program outputting map data on the display, a markup language renderer overlaying the markup language content on the map data output by the map display program, and a controller for controlling operation of the personal navigation device.

It is an advantage that the present invention provides a quick and easy way to update or enhance existing map data that is displayed on the personal navigation device. In this way, displayed data can be updated without the need for map data or software of the personal navigation device to be completely updated.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a personal navigation device according to the present invention.

FIG. 2 shows an example of a markup language content overlaying process of the present invention.

### DETAILED DESCRIPTION

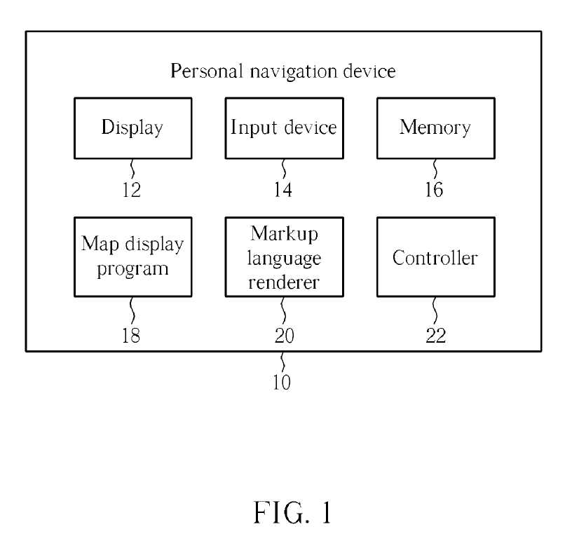

Please refer to FIG. 1. FIG. 1 is a block diagram of a personal navigation device 10 according to the present invention. The personal navigation device 10 contains a display 12 for displaying map data, overlayed markup language content, and other features of a user interface. A user can provide the personal navigation device 10 with input using an input device 14, such as input buttons or a touch-sensitive display. A memory 16 is provided for storing software and firmware of the personal navigation device 10, map data, and markup language content. A map display program 18 is used for displaying map data on the display 12 of the personal navigation device 10. The present invention personal navigation device 10 utilizes a markup language renderer 20 for rendering markup language content and overlaying the rendered markup language content on map data shown on the display 12. A controller 22 is used for controlling operation of the personal navigation device 10, and executes both firmware and software of the personal navigation device 10 along with executing the markup language renderer 20. Of course, the personal navigation device 10 may also contain numerous other parts, as is known to those skilled in the art. However, only parts of the personal navigation device 10 that are relevant to the present invention are shown in FIG. 1.

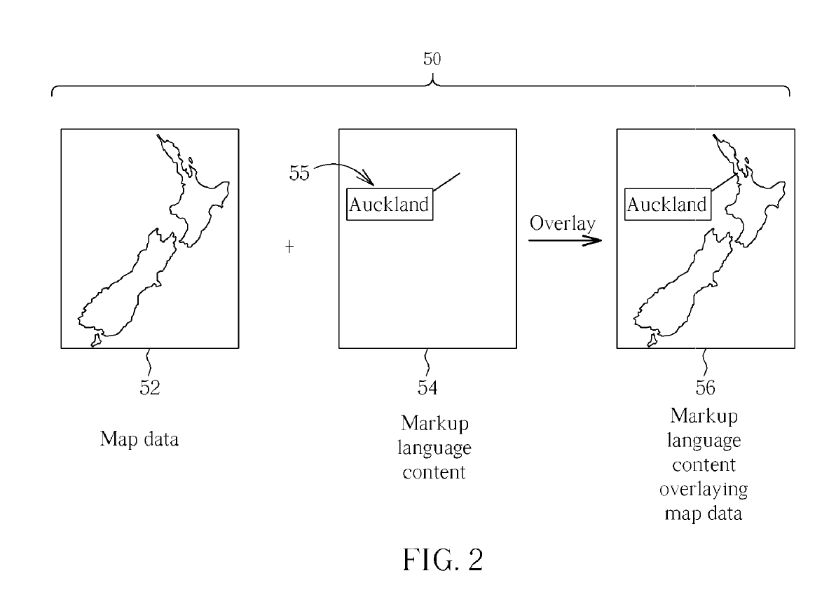

Please refer to FIG. 2, which shows an example of a markup language content overlaying process 50 of the present invention. As shown in FIG. 2, frame 52 contains map data supplied by the map display program 18 that shows a map of New Zealand. Frame 54 contains markup language content, which is rendered by the markup language renderer 20, having label 55 that corresponds to the map data shown in frame 52. Next, the markup language content from frame 54 is overlayed on the map data from frame 52 to produce the overlayed result shown in frame 56.

The markup language content can serve many purposes. By overlaying the map data, the markup language content can update old map data, correct incorrect map data, update GUI styles used by the personal navigation device 10, display advertisements or hyperlinks relevant to the map data being displayed, or other similar uses. In addition, when the personal navigation device 10 is being used for navigation, the markup language can be used to show movement of the personal navigation device 10 as well as upcoming turns on a selected route. The markup language will continue to show the movement of the personal navigation device 10 until the personal navigation device 10 moves out of the range of the markup language content.

Preferably, the markup language content is downloaded from a server via the internet or is stored in the memory 16 of the personal navigation device 10 in advance. The markup language content can be in the form of HyperText Markup Language (HTML) or eXtensible Markup Language (XML) files, although other formats can also be used.

The markup language content output by the markup language renderer 20 simply overlays the map data output by the map display program 18, and allows the map display program 18 to operate substantially in its normal fashion. In order for the markup language renderer 20 to know which markup language content to display, the markup language renderer 20 receives current map display parameters from the map display program 18. These parameters include the current position of the map data, information indicating whether the map data is displayed in two-dimensional mode or three-dimensional mode, information indicating whether the map data shown on the display of the personal navigation device is displayed in day mode or night mode, the angle at which the map data is displayed, the size and resolution of the display 12, etc. Once the markup language renderer 20 receives information from the map display program 18 on what map data is being displayed, the markup language renderer 20 searches for relevant markup language content to overlay on the map data. The markup language content contains text or images that are to be overlayed, as well as position information on where the markup language content is to be positioned on the display 12. The markup language content can completely overlay the underlying map data by making the markup language content opaque, or the markup language content can blend in with the map data by setting the properties of the markup language content to have partial translucency.

To minimize the lag caused by downloading the markup language content on demand, the markup language renderer 20 can download markup language content for areas adjacent to the currently displayed map data in advance and store the downloaded markup language content in the memory 16 for future use. In this way, the markup language renderer 20 can predict what map data the map display program 18 will be displaying next in order to have the corresponding markup language content ready to be displayed.

In cases where the display 12 is a touch-sensitive display, touch input is often used as a way to control the personal navigation device 10. However, since the markup language content overlays portions of the map data output by the map display program 18, the markup language renderer 20 can also receive the user's input when the user touches areas of the display 12 that are showing overlayed markup language content. The markup language renderer 20 can selectively filter the received touch input and can ignore touch input directed to all other areas of the display 12 that are not displaying overlaid markup language content. This touch input that is ignored by the markup language renderer 20 will be handled by the map display program 18. In another embodiment, the markup language renderer 20 can be set to ignore all touch input regardless of its position. For example, returning back to the overlaid map shown in frame 56 of FIG. 2, the markup language renderer 20 can receive touch input directed to the label 55 for providing more information about Auckland, but the markup language renderer 20 will ignore touch input directed to other parts of the map shown in frame 56, and will let the map display program 18 handle this touch input instead.

By allowing the markup language renderer 20 to receive touch input, the personal navigation device 10 can provide the user with more interactive content. For instance, the markup language content can include hyperlinks to websites containing tourist information or containing information on the history of the current area. Advertisements can also take advantage of the touch input by showing text or images that contain hyperlinks to the advertiser's website.

In summary, the present invention provides an efficient method of updating or enhancing existing map data. The markup language content is dynamically created, and can be updated constantly. As a result, users of the personal navigation device can receive updated map data, relevant information about the currently displayed map data, or updates to the GUI of the personal navigation device that cannot otherwise be obtained without going through the steps of updating the map data or the software of the personal navigation device. Furthermore, the markup language content represents only a small amount of data that needs to be downloaded to the personal navigation device, which provides a quick way to update the map data displayed on the personal navigation device without downloading all of the map data required for a region.

Those skilled in the art will readily observe that numerous modifications and alterations of the device and method may be made while retaining the teachings of the invention.

What is claimed is:

1. A method of overlaying markup language content on map data in a personal navigation device, the method comprising:
outputting map data on a display of the personal navigation device with a map display program;
receiving markup language content with a markup language renderer; and
overlaying the markup language content received by the markup language renderer on the map data output by the map display program.

2. The method of claim 1, wherein the markup language renderer downloads the markup language content from a server.

3. The method of claim 2, wherein the markup language content is downloaded when it is required to be displayed by the markup language renderer.

4. The method of claim 2, wherein the markup language content is downloaded in advance and stored in a memory for later use.

5. The method of claim 1, wherein the markup language content is overlayed on the map data with partial translucency.

6. The method of claim 1, wherein the markup language renderer receives current map display parameters from the map display program and outputs relevant markup language content accordingly.

7. The method of claim 6, wherein the current map display parameters comprise the current position of the map data shown on the display of the personal navigation device.

8. The method of claim 6, wherein the current map display parameters comprise information indicating whether the map data shown on the display of the personal navigation device is displayed in two-dimensional mode or three-dimensional mode.

9. The method of claim 6, wherein the current map display parameters comprise information indicating whether the map data shown on the display of the personal navigation device is displayed in day mode or night mode.

10. The method of claim 1 further comprising:
receiving input from a user of the personal navigation device; and
the markup language renderer filtering input received from the user by handling input directed to areas displaying overlayed markup language content and by ignoring input directed to other areas.

11. A personal navigation device overlaying markup language content on displayed map data, the personal navigation device comprising:
a display for displaying map data and overlayed markup language content;
an input device for receiving input from a user of the personal navigation device;
a memory for storing map data and markup language content;
a map display program outputting map data on the display;
a markup language renderer overlaying the markup language content on the map data output by the map display program; and
a controller for controlling operation of the personal navigation device.

12. The personal navigation device of claim 11, wherein the markup language renderer downloads the markup language content from a server.

13. The personal navigation device of claim 12, wherein the markup language content is downloaded when it is required to be displayed by the markup language renderer.

14. The personal navigation device of claim 12, wherein the markup language content is downloaded in advance and stored in the memory for later use.

15. The personal navigation device of claim 11, wherein the markup language content is overlayed on the map data with partial translucency.

16. The personal navigation device of claim 11, wherein the markup language renderer receives current map display parameters from the map display program and outputs relevant markup language content accordingly.

17. The personal navigation device of claim 16, wherein the current map display parameters comprise the current position of the map data shown on the display of the personal navigation device.

18. The personal navigation device of claim 16, wherein the current map display parameters comprise information indicating whether the map data shown on the display of the personal navigation device is displayed in two-dimensional mode or three-dimensional mode.

19. The personal navigation device of claim 16, wherein the current map display parameters comprise information indicating whether the map data shown on the display of the personal navigation device is displayed in day mode or night mode.

20. The personal navigation device of claim 11, wherein the markup language renderer filters input received from the user by handling input directed to areas displaying overlayed markup language content and by ignoring input directed to other areas.
